(19) United States
(12) Patent Application Publication
(10) Pub. No.: US 2025/0031056 A1
(43) Pub. Date: Jan. 23, 2025

(54) RAY TRACING

(71) Applicant: Telefonaktiebolaget LM Ericsson (publ), Stockholm (SE)

(72) Inventors: Sinh NGUYEN, GÖTEBORG (SE); Henrik Asplund, STOCKHOLM (SE); Magnus Lundevall, SOLNA (SE); Martin Johansson, MÖLNDAL (SE); Germán Ceballos, UPPSALA (SE)

(21) Appl. No.: 18/714,552

(22) PCT Filed: Dec. 16, 2021
(86) PCT No.: PCT/SE2021/051272

§ 371 Date: May 29, 2024

(51) Int. Cl. H04W 16/18; H04B 17/391

(52) U.S. Cl. CPC H04W 16/18; H04B 17/3912

(57) ABSTRACT

There is disclosed a method of operating a ray tracing system, the method comprising launching rays from one or more transmission objects for determining rays hitting one or more reception objects, wherein launching comprises launching a successor ray based on a predecessor ray hitting a proximity object, wherein the proximity object encloses a reception object. The disclosure also pertains to related devices and methods.

### TECHNICAL FIELD

This disclosure pertains to ray tracing, in particular in the context of wireless communication technology.

### BACKGROUND

Ray tracing is an approach that may be used for modelling radio channels and/or radio propagation, for example radio frequency (RF) deterministic propagation modelling in industrial and commercial tools. With higher frequencies, larger bandwidths, and more antennas expected to be utilised in future systems, e.g., 5G and beyond, 6G, and high-accuracy positioning systems, having an accurate deterministic propagation model that provides fast or real-time representation of the multipath propagation channel is becoming increasingly relevant.

Existing methods in ray tracing based RF propagation modelling launch and trace a large number of rays generated from a plurality of points (transmission objects) representing RF transmitters' positions to a plurality of points (reception objects) representing RF receivers' positions, in a three-dimensional space. Due to the discrete and ray-optics nature of the ray tracing methods, the RF receivers are normally represented by reception objects such as spheres with finite radius (rather than points) to capture rays intersecting with them. The paths from each of the transmitters to each of the receivers may be used to calculate path loss and other propagation channel parameters.

The finite size of the reception objects may cause issues. On one hand, for a given ray launch resolution, making the reception objects larger increases the probability of a hit, i.e. that a propagation path successfully leads to the ray being captured at a reception object. Hence, increasing the reception size allows for a reduction of the launch resolution which immediately translates into a complexity reduction since fewer rays need to be launched and traced. On the other hand, using a large reception object may rule out detection of whether the reception point is shadowed or not by an obstacle in the vicinity of the ray path, since parts of the reception object may be visible even if the true reception point is shadowed. In case the reception object represents a RF receiver, this can cause undesirable effects such as LOS (line-of-sight) to NLOS (non-line-of-sight) transitions taking place in the wrong location, indoor users behaving as if they are outdoor, small objects becoming practically invisible, etc. Such effects may create a faulty representation of the propagation channel.

As an example, to be able to get at least one ray per wave front captured at an RF receiver represented by a sphere with radius R for a path travelling with a total distance L=1 km from a RF transmitter's position, the minimum shooting resolution needs to be at least (\sqrt{3}R)/L radians, which is approximately 0.001 degree if R=0.01 m. This equivalently requires at least 43 billion rays to be launched at the RF transmitter position, assuming that rays are launched uniformly in a triangular grid over a full sphere. The number of required rays, which is translated to the tracing or simulation time, can be reduced by a factor of 250 000 if the sphere radius is set to 5 m instead. However, the above-mentioned problem of shadowed/non-shadowed state determination occurs for this path. Similar problems would happen for cylinders and corner spheres, representing object edges and object corners, respectively, used for capturing diffraction events.

### SUMMARY

It is an object of this disclosure to provide approaches improving ray tracing, in particular facilitating use of a comparatively low number of rays while accurately handling shadowing and/or obstacles. Thus, processing load may be limited, which may facilitate real-time processing and/or require low processing power and/or provide more sustainable operation—for example, for the processing itself, and/or by providing improved network operation controlled by the ray tracing system, which may beneficially impact resource use in the network.

There is disclosed a method of operating a ray tracing system. The method comprises launching rays from one or more transmission objects for determining rays hitting one or more reception object, wherein launching comprises launching a successor ray based on a predecessor ray hitting a proximity object. The proximity object encloses a reception object.

In general, a ray tracing system may be adapted for performing ray tracing. Performing ray tracing may be generally be considered a method of simulating signal propagation and/or signalling, in particular of electromagnetic signalling like visible light or radio waves, and/or may be considered a simulation. Performing ray tracing may in particular pertain to radio signalling and/or wireless communication, e.g. using radio waves. Ray tracing may be a computer-implemented method; a ray tracing system may generally comprise one or more processing circuitry or circuits, e.g. one or more computers and/or ASICs and/or FPGAs and/or controllers like microcontroller. Actions associated to ray tracing may be performed on the ray tracing system, e.g. automated and/or software-controlled and/or firmware-controlled. A ray may be considered representing signalling and/or a signal like an electromagnetic signal, and/or the path or channel or trajectory of such a signal or signalling. A ray may be represented and/or simulated and/or treated as 1-dimensional object (1D object, e.g. line or number of lines connected at interaction points), 2-dimensional object or 3 dimensional object (e.g., one or more cones and/or wave structures and/or tubes and/or beams in 2D or 3D, e.g. allowing representation and/or simulation and/or consideration of dispersion and/or expansion), e.g. depending on the setup and/or type of the simulation. A ray may be represented by one or more objects of the same dimensionality, e.g. connected at one or more interaction points, e.g. representing interactions with environment objects, for example reflection, and/or diffraction and/or absorption.

Performing ray tracing may comprise and/or be based on, and or the ray tracing system may be adapted for, simulating an environment, and/or providing a simulation of an environment. The environment may comprise and/or represent one or more radio objects and/or one or more transmitters; a transmitter may be represented by an transmission object. The environment may comprise and/or represent one or more receivers; a receiver may be represented by an reception object. The environment may comprise one or more environmental objects (e.g., not transmitters or receivers), e.g. representing potential obstacles and/or reflectors and/or absorbers. One or more radio objects and/or transmission objects and/or reception objects and/or environmental objects (e.g., persons and/or vehicles) may be mobile or static, or a mixture of mobile and static. For example, radio objects representing user equipments and/or IAB (Integrated Access and Backhaul) nodes may be represented as mobile. The ray tracing system may be adapted to receive, and/or base performing ray tracing based on, a map of the environment and/or information representing one or more (e.g., radio or environmental) objects and/or position information pertaining to one or more objects, and/or movement information pertaining to one or more objects, and/or communication information (e.g., indicating load and/or communication behaviour and/or capability and/or requests from on or more radio nodes). It may be considered that such information (or part thereof) may be provided to the ray tracing system once, or dynamically, e.g. in real-time or in regular or aperiodic time intervals). The environment may represent a real environment, or an exemplary environment, and/or an operational network or system, or to be configured system or network, for example a radio access network or wireless communication network. The ray tracing may be performed simultaneously to operation of the system, and/or control information determined based on the ray tracing may be provided to the network, and/or one or more radio nodes, e.g. control information indicating scheduling information and/or resources to be used. An environment may be considered represented by a simulation and/or be a simulation when represented by the ray tracing system. In some cases, a simulation and/or environment may be 2-dimensional or 3-dimensional. It should be noted that the environment or simulation may be of the same, or higher dimensionality than a ray. A ray may in general be considered a representation or simulation of signalling; performing ray tracing may comprise simulating and/or representing propagation and/or expansion and/or time behaviour of a ray in an environment. Performing ray tracing in general may comprise determining whether a ray hits a target (e.g., a reception object), and/or determining one or more propagation paths starting at a transmission object and/or ending at a target or reception object. It may be considered that a transmission object may represent a transmitter or receiver of signalling, and/or a reception object may represent a transmitter of receiver of signalling. For example, the representation of a radio node in the ray tracing system may be in the opposite communication or signalling direction then it is used or studied for (for, example, a transmitting node may be represented as reception objects, or vice versa), considering that propagation paths may be considered valid for both propagation directions. The environment may be static, or dynamic, and/or comprise dynamic objects in a static surrounding, e.g. individual moving objects in a static map. Performing ray tracing may comprise launching a plurality of rays, e.g. 100000 or more, or one million or more, or 10 s of millions or more e.g. depending on use case.

A proximity object may represent, and/or define, a surrounding of a reception object, e.g., including and/or encompassing the reception object. The proximity object may be larger than the reception object, and/or have a size larger than a point; in some cases, it may have a size at least 3 times, or at least 5 times, or at least 10 times, or at least 20 times of the reception object (according to the scaling or representation used in the ray tracing system). It may be considered that one or more proximity objects of different structures (e.g., size and/or shape) are associated to the same reception object, e.g. providing an onion-like structure of two or more proximity objects surrounding the reception object. A proximity object may in general have associated to it a structure, e.g. size (larger than a point) and/or form and/or shape and/or reception capability. It may be considered that a position and/or location and/or arrangement in space and/or direction and/or movement is associated to a reception object and/or proximity object; in may be considered that movement of a reception object and associated proximity objects correspond to each other, e.g. such that the reception object always is surrounded by the associated proximity object/s.

A radio object may be represented as a point object, or as having a structure and/or form or shape. The structure may represent a size and/or form and/or reception or transmission arrangement (e.g., antenna arrangement and/or beam form, e.g. for transmission, or for reception beam forming). An object may be considered hit if the propagation path of the ray and the object coincide in the simulation/ray tracing; one or more additional condition may apply, e.g. regarding angle of incidence of the ray and/or power level or energy of the ray at the point of interest. For example, a weak ray (e.g., with a power level or energy below a threshold), may be considered not hitting even if the propagation path and object coincide. This may allow considering cases in which a signal would be too weak to be received by the reception object. A transmission object and/or radio object and/or reception object may be represented by a sphere or cylinder in some cases. A reception object (or transmission object or radio object) may have a centre, e.g. the centre of a sphere.

A transmission object and/or reception object may be considered an example of a radio object, e.g. in a radio signalling scenario. A radio object and/or transmission object and/or reception object may be considered representative of a radio node. A transmission object generally may represent a transmitter of signalling, a reception object may represent a receiver of signalling. An object like a radio object may be a transmission object and reception object in one, e.g. for different times of the ray tracing (e.g., when simulation communication in two directions), or for interference analysis, or for radar use (e.g., for mono-static radar). In general, a ray may represent communication signalling and/or sensing signalling. Performing ray tracing may comprise simulation communication signalling and/or sensing signalling from the same transmission object, e.g. simultaneously or at different times, and/or in the same directions and/or different directions. Signalling and/or a ray may be represented based on, and/or considering, and/or may represent, wave form, and/or beam forming (e.g., shape), and/or power level (e.g., transmission power, and/or path loss), and/or modulation scheme, and/or channel structure (e.g., type of physical channel, e.g. control channel or data channel), and/or transmission timing structure (e.g., frame structure and/or duration and/or time domain arrangement of symbols), and/or time domain structure or behaviour (e.g., timing, time development), and/or frequency domain structure or behaviour (e.g., carrier frequency and/or bandwidth and/or frequency distribution of signalling, and/or time-dependent behaviour), and/or phase structure and/or behaviour, and/or code structure, and/or signalling sequence. Performing ray tracing may be based on and/or comprise simulating effects on, and/or interaction of the environment and/or one or more environmental objects with, a ray, e.g. diffusion and/or path-loss, and/or delay, and/or reflection, and/or absorption, and/or ray-splitting (e.g., for considering multi-path effects), and/or diffraction. To a transmission object and/or reception object and/or radio object, there may be associated, and/or such object may be parametrised by, location and/or position and/or movement and/or a structure, e.g. size and/or shape and/or reception capability and/or interaction capability. It may be considered that a reception object is not necessarily a radio node, but an object targeted by sensing or a radar target.

A ray may be parametrised and/or represented by one or more launch characteristics. A launch characteristic may indicate and/or comprise direction of launch of the ray (also referred to as angle, or launch angle, or launch direction), e.g. absolutely in a coordinate system of the environment or simulation, or relatively, e.g. to a transmission object (for example, if this is structured), like a spatial direction and/or in 2D, or 3D, e.g. based on the dimension of the simulation or environment, and/or transmission power level and/or signal form (e.g., beam form or dimension, or line or cone) and/or timing, and/or one or more other ray or signalling characteristics indicated herein. A characteristic of a ray may change over propagation, e.g. due to interaction with the environment and/or one or more environmental objects. A launch characteristic may be considered representing a ray characteristic at launch from the transmission object.

Approaches described herein facilitate efficient ray tracing, e.g. providing propagation paths for signalling with low processing cost. In particular, hits on small or point-sized reception objects may be determined efficiently.

In general, it may be considered that the successor ray may be parametrised based on the predecessor ray. In particular, one or more launch characteristics of the successor ray may be based on the predecessor ray. In particular, a launch direction of the successor ray may be based on a launch direction of the predecessor ray. In particular, it may be shifted in angle relative to the direction of the angle of the predecessor ray. The shift may be such that the ray propagates closer to a proximity object (e.g., one it hit, and/or one smaller proximity object surrounded by a larger one) and/or reception object than the predecessor ray.

It may be considered that the successor ray may be parametrised based on the proximity object. In particular, one or more launch characteristics of the successor ray may be based on the proximity object. Parametrisation based on the proximity object may comprise determining the launch characteristic based on whether the predecessor ray hits the proximity object (or not) and/or based on the size and/or structure of the proximity object, e.g. such that the successor ray has an increased chance of hitting the proximity object. In some cases, the successor ray may be parametrised based on a predecessor ray of a predecessor ray, e.g. one or more launch characteristics may be based thusly, and/or may be based on the predecessor ray. For example, if a predecessor ray which itself is a successor ray of a ray hitting a proximity object, but does not hit it itself, a new successor ray may be determined based on information (e.g., launch characteristics) of both predecessor rays. In general, parametrisation based on the proximity object may comprise parametrisation based on whether the proximity object was hit, and/or structure and/or position and/or behaviour (e.g., movement) of the proximity object. In some variants, the successor ray may be parametrised based on the proximity object such that it is parametrised based on location of the hit on the proximity object, and/or angle of incidence of the ray on the proximity object, and/or distance or shift between hit and reception object.

In general, a shift or derivation in one or more launch characteristics between a predecessor ray and a successor ray may be dependent on the proximity object and/or the predecessor ray and/or a predecessor of the predecessor ray and/or reception object; for example, the size of the shift and/or direction of the sift (e.g., angular direction) may be dependent on whether the predecessor ray hit the proximity object and/or reception object or not. In some cases, for example, the size of the shift may be smaller if the proximity object was hit than if it was not, which may allow a scanning using a larger angle (which may be fixed), and fine-tuning if the proximity object is hit. It may be considered that signalling characteristics (like frequency/carrier frequency, modulation, power level, waveform, signal shape) of predecessor and successor ray are the same; for example, predecessor ray and successor ray may share a set of launch characteristics and/or signalling characteristics, with one of more differences or shifts (in particular, with exactly one difference or two, or three differences or shifts), e.g. regarding direction and/or timing. It may be considered that a successor ray is based on a reception object, e.g. such that it is aimed at (e.g., based on a suitably selected launch angle or shift of launch angle) at the reception object, e.g. a centre of the reception object

It may be considered that the successor ray has a different angle (or direction, in particular at launch) than the predecessor ray and is parametrised to hit the proximity object. This may be based on position and/or location and/or movement and/or structure of the proximity object. In particular, the successor ray may be parametrised to be closer to the reception object and/or to hit the reception object. Thus, a deterministic ray launch may be performed utilising information obtained from hitting the proximity object. This may allow particularly efficient processing.

In some cases, a second successor ray may be launched based on the successor ray not hitting the proximity object and/or the reception object. This successor ray may be parametrised based on the predecessor ray and/or the successor ray (which may be considered predecessor and preceding predecessor for the second successor ray, respectively) and/or the proximity object. In particular, the launch angle of the second successor ray may be shifted relative to the launch angle of the successor ray, e.g. mirrored relative to the launch angle of the predecessor ray of the successor ray. This facilitates finely tuned search for promising rays, which may hit the reception object, with low processing cost.

In general, the rays launched may represent radio signalling. The approaches herein may in particular be useful for the propagation simulation of such signalling. Radio signalling may comprise, and/or be, communication signalling and/or sensing signalling. Communication signalling may represent downlink signalling and/or uplink signalling and/or sidelink signalling (e.g., between user equipments/wireless devices).

It may be considered that channel properties for radio signalling may be estimated and/or determined based on rays. Approaches allow determining propagation paths, and/or propagation conditions in the simulation, based on which a network may be configured and/or controlled.

In some cases, the proximity object may be a 2D or 3D representation. The proximity object may have the same or a larger dimension as the reception object, and/or the same or a smaller dimension as the environment. This allows flexibility in the use and setup of the simulation.

There may be considered multiple proximity objects, each of which may enclose a different reception object. Thus, a plurality of reception object may be handled. Proximity objects associated to different reception objects may be similar or the same in terms of structure, in particular regarding size and/or shape. In some cases, they may be different in terms of structure, in particular regarding size and/or shape, e.g. allowing differences in handling different types of reception objects (e.g., network nodes and user equipments, or static or moving user equipments).

It may be considered that performing ray tracing comprises and/or is based on, simulating an environment, wherein the one or more transmission objects may represent actual transmitters of radio signalling in the environment, and/or the one or more reception objects may represent actual receivers in the environment. Thus, a close representation of a real system may be provided, facilitating obtaining highly relevant information from the simulation.

The method may be based on, and/or the ray tracing system may be adapted for performing ray tracing based on, measurement information and/or environment information received by the ray tracing system. The measurement information may represent measurements performed by one or more radio nodes, which may be represented as radio objects in the ray tracing system and/or simulation. A measurement may represent measurement pertaining to channel condition/s and/or inference and/or signal strength and/or signal quality and/or delay and/or timing and/or frequency and/or phase and/or channel quality of radio signalling; measurement information may be based on, and/or represented by, a measurement report, which may be transmitted and/or provided to the ray tracing system from one or more radio nodes and/or network nodes. The ray tracing system may be adapted to receive and/or evaluate such information, for example when determining environment effect on ray propagation. Environment information may represent a map, and/or one or more objects, and/or position and/or movement and/or structure and/or interaction characteristic/s of one or more objects. Setup and/or operation of the simulation or ray tracing system close to actual conditions may thus be facilitated.

It may be considered that the ray tracing system is adapted for providing, and/or provides, information to, and/or is adapted for controlling, and/or controls, one or more (e.g., radio) nodes of a wireless communication network, e.g. based on rays determined to hit one or more of the reception object. The information may indicate propagation channels determined using ray tracing, and/or scheduling information, and/or channel estimates and/or indication of scheduling, e.g. scheduling targets and/or beam directions and/or power level, e.g. for upcoming communication and/or sensing.

Alternatively, or additionally, it may be considered that the successor ray is parametrised based on an environmental object and/or an interaction (and/or interaction region associated to the interaction). Parametrisation based on an environmental object and/or interaction may comprise parametrising and/or changing and/or shifting one or more launch characteristics for the successor ray based on a predecessor ray hitting an environmental object and/or an interaction (or region) like diffraction and/or reflection. In some cases, to the interaction region and/or interaction and/or environmental object, there may be associated an (intermediate, also referred to as environmental or interaction) proximity object, which may have a similar structure (e.g., same size and/or shape) as the proximity object associated to the reception object, or a different structure. The intermediate proximity object may surround and/or include and/or be larger than an interaction area of an object, e.g. a building corner or wall edge. Parametrisation based on the environmental object and/or interaction may be based on the intermediate proximity object, e.g. one or more launch characteristics (e.g., angle) may be shifted for the successor ray based on the predecessor ray hitting the intermediate proximity object; for example, it may be shifted to hit the environmental object (e.g., its centre) or an interaction region. The parametrisation may be based on one or more characteristics of the intermediate proximity object and/or the environmental object and/or interaction and/or interaction region, e.g. location and/or structure (e.g., size and/or shape) and/or type of interaction, e.g. reflection and/or diffusion and/or diffraction.

In general, there may be considered a ray tracing system adapted to perform any method or approach as described herein. The ray tracing system may comprise, and/or be connected to, one or more radio nodes (e.g., via communication circuitry and/or an interface). It may be considered that the ray tracing system is adapted for controlling, and/or for providing information for, or to, one or more radio nodes (to which it may be connected directly, or indirectly) based on the performed ray tracing. This may correspond to a real-time control of the network (represented by the radio node/s), and/or a configuration or setup of the network, e.g. determining propagation paths for signalling to circumvent obstacles, e.g. for future use if a potential receiver moves behind such an obstacle. Control and/or information provided by the ray tracing system may pertain to communication and/or sensing, and/or indicate transmission characteristics and/or scheduling information, e.g. indicating transmitting radio nodes and/or receiving radio nodes, and/or beam directions and/or sizes and/or shapes (e.g., for one or more transmission beams and/or reception beams), and/or propagation path/s and/or transmission power level and/or path-loss and/or channel conditions and/or channel estimates, and/or time/frequency resources, and/or information pertaining to link adaptation. The ray tracing system may be, and/or comprise, and/or be implemented in, a radio node, e.g. a network node, or a node adapted for controlling and/or communicating with a radio node.

There is generally considered a program product comprising instructions adapted for causing processing and/or control circuitry to carry out and/or control any method described herein, in particular when executed on the processing and/or control circuitry. Also, there is considered a carrier medium arrangement carrying and/or storing a program product as described herein. The program product may comprise computer-readable instructions and/or code, which may be implemented in modules, e.g. a module each for each action described herein. It may be considered that the program product comprises a module for launching a predecessor ray and/or successor ray, and/or for determining a hit on a proximity object and/or reception object, and/or for determining a propagation paths and/or for determining interaction and/or for simulating the environment and/or for receiving information and/or for providing information and/or for performing ray tracing.

The approaches described are particularly suitable for radio communication, in particular high frequency/millimetre wave communication, in particular for radio carrier frequencies around and/or above 52.6 GHz, which may be considered high radio frequencies (high frequency) and/or millimetre waves. The carrier frequency/ies may be between 52.6 and 140 GHz, e.g. with a lower border between 52.6, 55, 60, 71 GHz and/or a higher border between 71, 72, 90, 114, 140 GHz or higher, in particular between 55 and 90 GHz, or between 60 and 72 GHz; however, higher frequencies may be considered, in particular frequency of 71 GHz or 72 GHz or above, and/or 100 GHz or above, and/or 140 GHz or above. The carrier frequency may in particular refer to a center frequency or maximum frequency of the carrier. The radio nodes and/or network described herein may operate in wideband, e.g. with a carrier bandwidth of 1 GHz or more, or 2 GHz or more, or even larger, e.g. up to 8 GHz; the scheduled or allocated bandwidth may be the carrier bandwidth, or be smaller, e.g. depending on channel and/or procedure. In some cases, operation may be based on an OFDM waveform or a SC-FDM waveform (e.g., downlink and/or uplink), in particular a FDF-SC-FDM-based waveform. However, operation based on a single carrier waveform, e.g. SC-FDE (which may be pulse-shaped or Frequency Domain Filtered, e.g. based on modulation scheme and/or MCS), may be considered for downlink and/or uplink. In general, different waveforms may be used for different communication directions. Communicating using or utilising a carrier and/or beam may correspond to operating using or utilising the carrier and/or beam, and/or may comprise transmitting on the carrier and/or beam and/or receiving on the carrier and/or beam. Operation may be based on and/or associated to a numerology, which may indicate a subcarrier spacing and/or duration of an allocation unit and/or an equivalent thereof, e.g., in comparison to an OFDM based system. A subcarrier spacing or equivalent frequency interval may for example correspond to 960 kHz, or 1920 kHz, e.g. representing the bandwidth of a subcarrier or equivalent.

The approaches are particularly advantageously implemented in or for a future 6th Generation (6G) telecommunication network or 6G radio access technology or network (RAT/RAN in particular according to 3GPP (3rd Generation Partnership Project, a standardisation organization). A suitable RAN may in particular be a RAN according to NR, for example release 18 or later, or LTE Evolution. However, the approaches may also be used with other RAT, for example future 5.5G systems or IEEE based systems.

### BRIEF DESCRIPTION OF THE FIGURES

The drawings are provided to illustrate concepts and approaches described herein, and are not intended to limit their scope. The drawings comprise:

FIG. 1, showing an exemplary block diagram for performing ray tracing;

FIG. 2 showing an exemplary ray tracing scenario; and

FIG. 3 showing a further exemplary ray tracing scenario.

### DETAILED DESCRIPTION

It is proposed the introduction of proximity objects, which are larger objects enclosing reception objects. When a ray hits a proximity object, this signals that the ray could potentially hit the reception object, enclosed by the proximity object, e.g., if the launch direction was adjusted (slightly) to be in the direction of the center of the reception object. Given that the ray origin (transmission object) and the target point (e.g., the center of the reception object) are known, the ray can therefore be relaunched in a deterministically determined direction which is guaranteed to hit the center of the reception object-unless there is some blocking object that did not affect the ray hitting the proximity objects. Any interactions occurring between a launch point, or, in general, any point source in the path, and the receiver can be accounted for in the determination of the relaunch direction by the proposed approaches. The proximity object could for example be a sphere with a larger radius enclosing a reception sphere or a reception object, e.g. representing a RX receiver, or a larger cylinder surrounding an edge cylinder.

With the proposed solution, the execution time for RF propagation channel estimation can be dramatically reduced, which is crucial for real-time or time critical applications. A factor of 250 000 times problem size reduction may be possible, by using over-sized proximity objects and small reception objects, without the problem associated with over-sized reception objects identified above. Furthermore, correction of interaction points along the path may result in more accurate calculation of propagation channel path loss and other propagation-related measures and effects by the environment. By using proximity objects for capturing rays, the ray shooting resolution becomes independent of the size of the reception objects, and can instead be determined using environment factors such as street widths, sizes of objects in the propagation environment, etc. The proximity objects' size should be large enough to capture the relevant candidate paths.

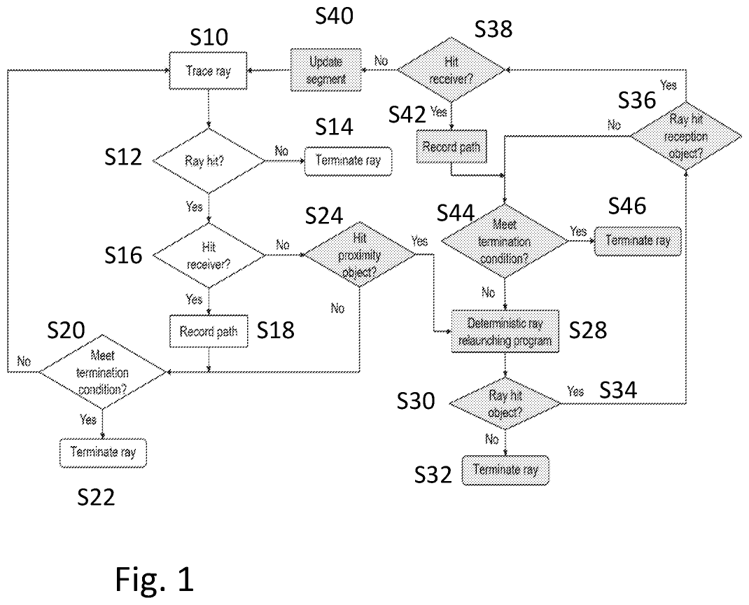

A block diagram of an exemplary approach is depicted in FIG. 1. In an action S10, a ray to be traced may be launched, e.g., having a first set of launch characteristics, which in particular may comprise and/or consist of a launch angle. In action S12, it may be determined whether the propagated ray hit an object. It not, the ray may be terminated in action S14; S12 and S14 may be omitted in some cases. If yes, it may be determined in action S16 whether a receiver (reception object) was hit. If yes, the (propagation) path and/or launch characteristic/s of the ray, and/or one or more characteristics or behaviours associated to the ray and its propagation may be recorded or stored in action S18; in action S20, it may be determined whether a termination condition for the ray tracing is met, e.g. based on the number of rays launched, and/or reception objects hit, and/or based on conditions for the ray, e.g. pertaining to power level and/or energy and/or path-loss and/or distance. If yes, the ray tracing and/or ray may terminated in action S22. If not, another ray may be launched by returning to action S10, wherein at least one launching characteristic (e.g., angle, or transmission object) may be changed.

If in action S16 it is determined that no receiver is hit, it may be branched to action S24, in which it may be determined whether a proximity object is hit. If not, it may be branched to action S20. If yes, action S28 of launching a successor ray may be performed, which also may be referred to as deterministic ray relaunching program (a relaunched ray may be considered a successor ray). The ray launched at action S10 may be considered predecessor ray for the next successor ray. In action S28, the successor ray may be launched, based on the predecessor ray and/or the proximity object. At least (or only) one, or at most three or less, launch characteristics of the successor ray may differ from the predecessor ray, e.g. the launch angle. In action S30, it may be determined whether the successor ray hit an object. If no, in action S32, the ray may be terminated; for example, the ray tracing may be stopped, or it may be proceeded with another ray according to action S10. If the successor ray hit the object, it may be determined in action S36 whether the object is a proximity object, or reception object/receiver. If yes, in action S38 it may be determined whether it is a receiver (S38 and S36 may be combined in one action). If no, in S40 a segment update for the ray may be used, and it may be returned to action S10. If yes, in S43 information may be stored as in action S18, e.g. a the path may be recorded. Based on this, in action S44 it may be determined whether a termination condition has been achieved; if yes, in action S46, the ray may be terminated, or it may be returned to action S28 with a new successor ray.

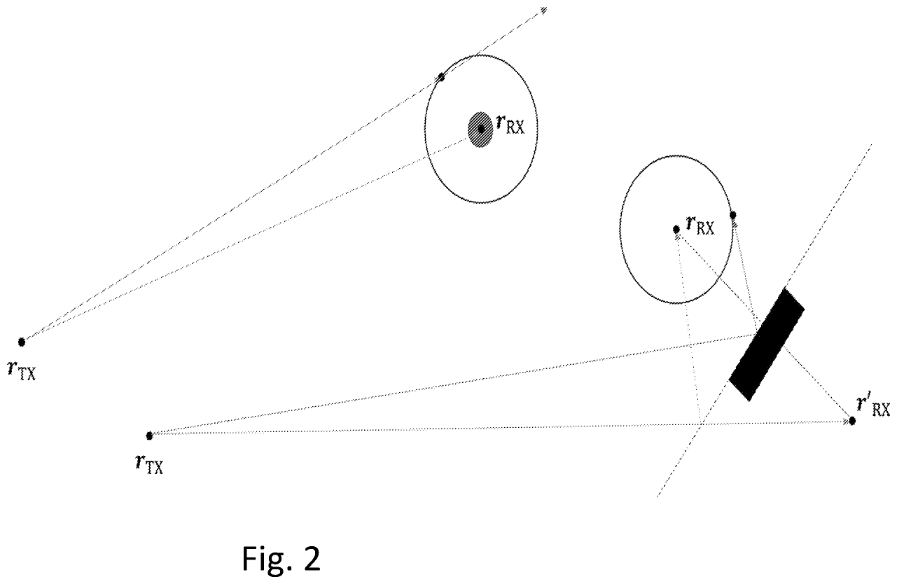

FIG. 2 shows an exemplary ray tracing scenario. There are shown two exemplary transmission objects rₜₓ and two exemplary reception objects rᵣₓ; the lower reception object is implemented as a reception point, the upper as a sphere around a reception center. Surrounding both reception objects there are shown proximity objects as full lines, in this example implemented as spheres or circles (a circle may be seen as 2D sphere). From each transmission object, there is shown one ray launched hitting the proximity object of the corresponding reception object. In the upper case, a relaunched (successor) ray is directed at the center of the reception object based on hitting the proximity object with the predecessor ray, and based on the launch characteristics of the predecessor ray and information about location and structure of the proximity object and/or reception object. In the second example, the original (predecessor) ray has reflected on an object before hitting the proximity sphere. The ray is relaunched (as successor ray) towards an image r′_{R}X of the receiver position r_{R}X. However, the relaunched ray misses the reflecting object, and is not reflected, and therefore misses the receiver, hence this path is not recorded. The relaunch direction for the successor ray is found from the geometry based on image theory, using mirroring of the target in all specular reflection surfaces that the predecessor ray has encountered.

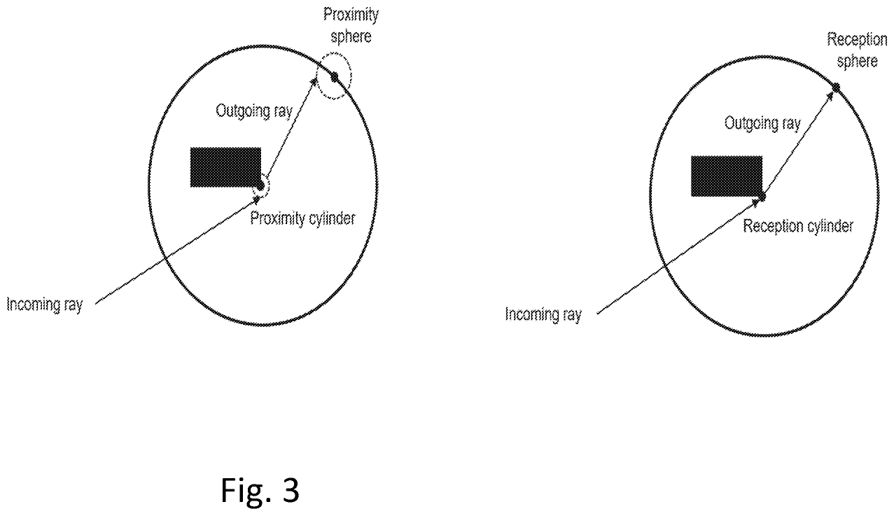

FIG. 3 shows an example of having a proximity sphere for the receiver and a proximity object like a cylinder for an environmental object, e.g. for some building edge. An interaction like a diffraction interaction may be captured based on the proximity object of the environmental object/interaction; a successor beam may be launched (the beam may be relaunched) based on an interaction and/or based on the proximity object of the interacting object. Specifically, FIG. 3 shows the original diffracted ray hitting the proximity cylinder and the proximity sphere being relaunched toward the reception cylinder's center and/or the reception sphere center.

Interactions and/or effects like, and/or combination of, specular reflection and/or diffraction, and/or diffusion may also be relaunched in a similar fashion. The proposed approach is deployable in a cloud/compute cluster solution, the ray tracing system may be implemented a distributed system and/or cloud system and/or on one or more computers/processors.

There is suggested a launch-and-relaunch approach (of predecessor ray and a successor ray, for example) in particular for RF propagation modelling using ray tracing, in which rays hitting the introduced proximity objects at the RF receivers' position and/or objects like the building edges in the first launch may be relaunched so that the correct path points are recorded for proper path loss and channel parameter calculations. Approaches described facilitate fast and efficient execution and may avoid incorrect path and path-loss estimation that may occur in previous and currently existing methods based on finite resolution ray tracing.

There is generally considered a program product comprising instructions adapted for causing processing and/or control circuitry to carry out and/or control any method described herein, in particular when executed on the processing and/or control circuitry. Also, there is considered a carrier medium arrangement carrying and/or storing a program product as described herein. A carrier medium arrangement may comprise one or more carrier media. Generally, a carrier medium may be accessible and/or readable and/or receivable by processing or control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

A system comprising one or more radio nodes and/or implemented as a ray tracing system, as described herein, in particular a network node and a user equipment, is described. The system may be a wireless communication system, and/or provide and/or represent a radio access network. A radio node may generally be considered a device or node adapted for wireless and/or radio (and/or millimetre wave) frequency communication, and/or for communication utilising an air interface, e.g. according to a communication standard. A radio node may be a network node, or a user equipment or terminal. A network node may be any radio node of a wireless communication network, e.g. a base station and/or gNodeB (gNB) and/or eNodeB (eNB) and/or relay node and/or micro/nano/pico/femto node and/or transmission point (TP) and/or access point (AP) and/or other node, in particular for a RAN or other wireless communication network as described herein. The terms user equipment (UE) and terminal may be considered to be interchangeable in the context of this disclosure. A wireless device, user equipment or terminal may represent an end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment or terminal may be mobile or stationary. A wireless device generally may comprise, and/or be implemented as, processing circuitry and/or radio circuitry, which may comprise one or more chips or sets of chips. The circuitry and/or circuitries may be packaged, e.g. in a chip housing, and/or may have one or more physical interfaces to interact with other circuitry and/or for power supply. Such a wireless device may be intended for use in a user equipment or terminal.

A ray tracing system and/or a radio node may generally comprise processing circuitry and/or radio circuitry and/or communication circuitry and/or cable circuitry. A ray tracing system, and/or a radio node, in particular a network node, may in some cases comprise cable circuitry and/or communication circuitry, with which it may be connected or connectable to another radio node and/or a core network.

Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or hard disk memory, and/or EPROM or EEPROM (Erasable Programmable ROM or Electrically Erasable Programmable ROM).

Radio circuitry may comprise one or more transmitters and/or receivers and/or transceivers (a transceiver may operate or be operable as transmitter and receiver, and/or may comprise joint or separated circuitry for receiving and transmitting, e.g. in one package or housing), and/or may comprise one or more amplifiers and/or oscillators and/or filters, and/or may comprise, and/or be connected or connectable to antenna circuitry and/or one or more antennas and/or antenna arrays. An antenna array may comprise one or more antennas, which may be arranged in a dimensional array, e.g. 2D or 3D array, and/or antenna panels. A remote radio head (RRH) may be considered as an example of an antenna array. However, in some variants, an RRH may be also be implemented as a network node, depending on the kind of circuitry and/or functionality implemented therein.

Communication circuitry may comprise radio circuitry and/or cable circuitry. Communication circuitry generally may comprise one or more interfaces, which may be air interface/s and/or cable interface/s and/or optical interface/s, e.g. laser-based. Interface/s may be in particular packet-based. Cable circuitry and/or a cable interfaces may comprise, and/or be connected or connectable to, one or more cables (e.g., optical fiber-based and/or wire-based), which may be directly or indirectly (e.g., via one or more intermediate systems and/or interfaces) be connected or connectable to a target, e.g. controlled by communication circuitry and/or processing circuitry.

Any one or all of the modules disclosed herein may be implemented in software and/or firmware and/or hardware. Different modules may be associated to different components of a radio node, e.g. different circuitries or different parts of a circuitry. It may be considered that a module is distributed over different components and/or circuitries. A program product as described herein may comprise the modules related to a device on which the program product is intended (e.g., a user equipment or network node) to be executed (the execution may be performed on, and/or controlled by the associated circuitry).

A wireless communication network may be or comprise a radio access network and/or a backhaul network (e.g. a relay or backhaul network or an IAB network), and/or a Radio Access Network (RAN) in particular according to a communication standard. A communication standard may in particular a standard according to 3GPP and/or 5G, e.g. according to NR or LTE, in particular LTE Evolution.

A radio node may be a wireless device or user equipment. Alternatively, it may be a network node. A radio node adapted for wireless communication may be a radio node adapted for transmitting and/or receiving communication signalling. Communication signalling may be. and/or comprise, data signalling and/or control signalling and/or reference signalling, e.g. according to a wireless communication standard like a 3GPP standard or IEEE standard. A radio node adapted for sensing operation and/or radar operation may be adapted for, and/or be configured or configurable, for transmitting and/or receiving signalling for sensing or radar functionality, in particular according to a configuration for sensing and/or processing signalling. The radio node may share circuitry like processing circuitry and/or radio circuitry and/or antenna circuitry and/or antenna elements and/or sub-arrays between communication signalling and sensing operation and/or sensing signalling. The sensing operation may be mono-static (transmitter and receiver are the same) and/or multi-static (transmitter and receiver may be different). Sensing signalling may be reference signalling, and/or may be communication signalling and/or signalling dedicated for sensing. Sensing signalling may have different types of signalling, e.g. based on, or associated to use and/or object and/or sensing function (e.g., which parameters of an object are to be determined). Multiplexing communication signalling and sensing signalling in a multiplexing time interval may correspond to the communication signalling and the sensing signalling being transmitted in the multiplexing time interval, e.g. by the same node or different nodes. Operating utilising communication signalling may comprise transmitting and/or receiving communication signalling. Operating utilising sensing signalling may comprise transmitting and/or receiving sensing signalling. A radio node may be adapted for mono-static operation. In this case, it may be adapted for full-duplex operation, transmitting and receiving in fully or at least partially overlapping time intervals (e.g., corresponding to, and/or at least partially overlapping with, the multiplexing time interval), such that it may receive reflected sensing signalling it transmitted itself (due to the large speed of radio waves, the reflected sensing signalling will often be received while the radio node still transmits sensing signalling). The radio circuitry and/or processing circuitry and/or antenna circuitry of a radio node may be adapted both for handling communication signalling and sensing signalling. The radio node may be adapted for full-duplex operation, and/or half-duplex operation. Full duplex may refer to transmitting and receiving at the same time, e.g. using the same or different circuitries, and/or using different antenna sub-arrays or separately operable antenna sub-arrays or antenna elements.

In general, sensing signalling may be based on the same waveform as the communication signalling. However, it may be based on a different waveform in some variants. The sensing signalling may be OFDM based, for example, regular OFDM, or spread OFDM like DFT-s-OFDM, and/or pulse-shaped OFDM, or filter-bank based, or Single Carrier based. The communication signalling may be OFDM based, for example, regular OFDM, or spread OFDM like DFT-s-OFDM, and/or pulse-shaped OFDM, or filter-bank based, or Single Carrier based. The sensing signalling may be transmitted in a transmission timing structure corresponding to the transmission timing structure associated to the communication signalling, e.g. a frame structure, and/or be based on the same or a different numerology as the communication signalling. The timing structure (e.g., symbol duration or allocation unit duration) and/or types of modulation symbols carried by signalling may be based on the waveform used.

Communication may be based on communication signalling and/or be based in particular on multiple communication links and/or beams and/or with multiple targets (e.g., TRPs or other forms of transmission sources also receiving) and/or multiple layers at the same time; different reference signallings for multiple transmission or reception may be based on different sequence roots and/or combs and/or cyclic shifts. Thus, high throughput may be achieved, with low interference. In general, different reference signallings (e.g., of the same type) may be associated to different transmission sources and/or beams and/or layers, in particular if transmitted simultaneously and/or overlapping in time (e.g., considering different timing advance values if transmitted in uplink). For example, there may be first reference signalling transmitted using a first transmission source and/or first beam and/or first layer, and second reference signalling transmitted using a first transmission source and/or first beam and/or first layer. Communication may be based on ray tracing performed, e.g. determining layers and/or beams and/or time/frequency resources and/or transmitters and/or receivers for scheduling and/or link adaptation.

In general, the wireless device and/or network node may operate in, and/or the communication and/or signalling may be in, TDD operation. It should be noted that the transmission of signalling from transmission sources may be synchronised and simultaneous; a shift in time may occur due to different propagation times, e.g. due to different beams and/or source locations.

A wireless device or user equipment may in general comprise, and/or be adapted to utilise, processing circuitry and/or radio circuitry, in particular a transmitter and/or transceiver and/o receiver, to process (e.g., trigger and/or schedule) and/or transmit and/or receive signalling like data signalling and/or control signalling and/or reference signalling and/or to perform beam switching, e.g. based on information provided by the ray tracing system. A wireless device may be implemented as terminal or UE; in some cases, it may however be implemented as network node, in particular a base station or relay node or IAB node, in particular to provide MT (Mobile Termination) functionality for such. In general, a wireless device may comprise and/or be adapted for transmission or reception diversity, and/or may be connected or connectable to, and/or comprise, antenna circuitry, and/or two or more independently operable or controllable antenna arrays or arrangements, and/or transmitter circuitries and/or antenna circuitries, and/or may be adapted to use (e.g., simultaneously) a plurality of antenna ports, e.g. controlling transmission or reception using the antenna array/s, and/or to utilise and/or operate and/or control two or more transmission sources, to which it may be connected or connectable, or which it may comprise. The may comprise multiple components and/or transmitters and/or transmission sources and/or TRPs (and/or be connected or connectable thereto) and/or be adapted to control transmission and/or reception from such. Any combination of units and/or devices able to control transmission on an air interface and/or in radio as described herein may be considered a transmitting radio node.

A network node may comprise, and/or be adapted to utilise, processing circuitry and/or radio circuitry, in particular a receiver and/or transmitter and/or transceiver, to transmit and/or to process and/or receive (e.g. receive and/or demodulate and/or decode and/or perform blind detection and/or schedule or trigger) data signalling and/or control signalling and/or reference signalling, in particular first signalling and second signalling and/or the random access message. In some cases, a radio node may be a network node or base station or TRP, or may be an IAB node or relay node, e.g. providing control level functionality for such, e.g. DU and/or CU functionality. In some cases, e.g. sidelink scenarios, a radio node may be implemented as a wireless device or terminal or UE. A network node may comprise one or more independently operable or controllable receiving circuitries and/or antenna circuitries and/or may be adapted to utilise and/or operate to receive from one or more transmission source simultaneously and/or separately (in time domain), and/or to operate using (e.g., receiving) two or more antenna ports simultaneously, and/or may be connected and/or connectable and/or comprise multiple independently operable or controllable antennas or antenna arrays or subarrays.

A radio node may generally be considered a device or node adapted for wireless and/or radio (and/or millimeter wave) frequency communication, and/or for communication utilising an air interface, e.g. according to a communication standard.

A radio node may be a network node, or a user equipment or terminal. A network node may be any radio node of a wireless communication network, e.g. a base station and/or gNodeB (gNB) and/or eNodeB (eNB) and/or relay node and/or micro/nano/pico/femto node and/or transmission point (TP) and/or access point (AP) and/or other node, in particular for a RAN or other wireless communication network as described herein.

The terms user equipment (UE) and terminal may be considered to be interchangeable in the context of this disclosure. A wireless device, user equipment or terminal may represent an end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment or terminal may be mobile or stationary. A wireless device generally may comprise, and/or be implemented as, processing circuitry and/or radio circuitry, which may comprise one or more chips or sets of chips. The circuitry and/or circuitries may be packaged, e.g. in a chip housing, and/or may have one or more physical interfaces to interact with other circuitry and/or for power supply. Such a wireless device may be intended for use in a user equipment or terminal.

A radio node may generally comprise processing circuitry and/or radio circuitry. A radio node, in particular a network node, may in some cases comprise cable circuitry and/or communication circuitry, with which it may be connected or connectable to another radio node and/or a core network.

Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or hard disk memory, and/or EPROM or EEPROM (Erasable Programmable ROM or Electrically Erasable Programmable ROM).

Radio circuitry may comprise one or more transmitters and/or receivers and/or transceivers (a transceiver may operate or be operable as transmitter and receiver, and/or may comprise joint or separated circuitry for receiving and transmitting, e.g. in one package or housing), and/or may comprise one or more amplifiers and/or oscillators and/or filters, and/or may comprise, and/or be connected or connectable to antenna circuitry and/or one or more antennas and/or antenna arrays. An antenna array may comprise one or more antennas, which may be arranged in a dimensional array, e.g. 2D or 3D array, and/or antenna panels. A remote radio head (RRH) may be considered as an example of an antenna array. However, in some variants, an RRH may be also be implemented as a network node, depending on the kind of circuitry and/or functionality implemented therein.

Communication circuitry may comprise radio circuitry and/or cable circuitry. Communication circuitry generally may comprise one or more interfaces, which may be air interface/s and/or cable interface/s and/or optical interface/s, e.g. laser-based. Interface/s may be in particular packet-based. Cable circuitry and/or a cable interfaces may comprise, and/or be connected or connectable to, one or more cables (e.g., optical fiber-based and/or wire-based), which may be directly or indirectly (e.g., via one or more intermediate systems and/or interfaces) be connected or connectable to a target, e.g. controlled by communication circuitry and/or processing circuitry.

Any one or all of the modules disclosed herein may be implemented in software and/or firmware and/or hardware. Different modules may be associated to different components of a radio node, e.g. different circuitries or different parts of a circuitry. It may be considered that a module is distributed over different components and/or circuitries. A program product as described herein may comprise the modules related to a device on which the program product is intended (e.g., a user equipment or network node) to be executed (the execution may be performed on, and/or controlled by the associated circuitry).

A wireless communication network may be or comprise a radio access network and/or a backhaul network (e.g. a relay or backhaul network or an IAB network), and/or a Radio Access Network (RAN) in particular according to a communication standard. A communication standard may in particular a standard according to 3GPP and/or 5G, e.g. according to NR or LTE, in particular LTE Evolution.

A wireless communication network may be and/or comprise a Radio Access Network (RAN), which may be and/or comprise any kind of cellular and/or wireless radio network, which may be connected or connectable to a core network. The approaches described herein are particularly suitable for a 5G network, e.g. LTE Evolution and/or NR (New Radio), respectively successors thereof. A RAN may comprise one or more network nodes, and/or one or more terminals, and/or one or more radio nodes. A network node may in particular be a radio node adapted for radio and/or wireless and/or cellular communication with one or more terminals. A terminal may be any device adapted for radio and/or wireless and/or cellular communication with or within a RAN, e.g. a user equipment (UE) or mobile phone or smartphone or computing device or vehicular communication device or device for machine-type-communication (MTC), etc. A terminal may be mobile, or in some cases stationary. A RAN or a wireless communication network may comprise at least one network node and a UE, or at least two radio nodes. There may be generally considered a wireless communication network or system, e.g. a RAN or RAN system, comprising at least one radio node, and/or at least one network node and at least one terminal.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

In this disclosure, for purposes of explanation and not limitation, specific details are set forth (such as particular network functions, processes and signalling steps) in order to provide a thorough understanding of the technique presented herein. It will be apparent to one skilled in the art that the present concepts and aspects may be practiced in other variants and variants that depart from these specific details.

For example, the concepts and variants are partially described in the context of Long Term Evolution (LTE) or LTE-Advanced (LTE-A) or New Radio mobile or wireless communications technologies; however, this does not rule out the use of the present concepts and aspects in connection with additional or alternative mobile communication technologies such as the Global System for Mobile Communications (GSM) or IEEE standards as IEEE 802.11ad or IEEE 802.11 ay. While described variants may pertain to certain Technical Specifications (TSs) of the Third Generation Partnership Project (3GPP), it will be appreciated that the present approaches, concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

### SOME USEFUL ABBREVIATIONS COMPRISE

Abbreviation Explanation
ACK/NACK Acknowledgment/Negative Acknowledgement
ARQ Automatic Repeat reQuest
BER Bit Error Rate
BLER Block Error Rate
BPSK Binary Phase Shift Keying
BWP BandWidth Part
CAZAC Constant Amplitude Zero Cross Correlation
CB Code Block
CBB Code Block Bundle
CBG Code Block Group
CDM Code Division Multiplex
CM Cubic Metric
CORESET Control Resource Set
CQI Channel Quality Information
CRC Cyclic Redundancy Check
CRS Common reference signal
CSI Channel State Information
CSI-RS Channel state information reference signal
DAI Downlink Assignment Indicator
DCI Downlink Control Information
DFT Discrete Fourier Transform
DFTS-FDM DFT-spread-FDM
DM(-)RS Demodulation reference signal (ing)
eMBB enhanced Mobile BroadBand
FDD Frequency Division Duplex
FDE Frequency Domain Equalisation
FDF Frequency Domain Filtering
FDM Frequency Division Multiplex
HARQ Hybrid Automatic Repeat Request
IAB Integrated Access and Backhaul
IFFT Inverse Fast Fourier Transform
Im Imaginary part, e.g. for pi/2*BPSK modulation
IR Impulse Response
ISI Inter Symbol Interference
MBB Mobile Broadband
MIMO Multiple-input-multiple-output
MRC Maximum-ratio combining
MRT Maximum-ratio transmission
MU-MIMO Multiuser multiple-input-multiple-output
OFDM/A Orthogonal Frequency Division Multiplex/Multiple Access
PAPR Peak to Average Power Ratio
PDCCH Physical Downlink Control Channel
PDSCH Physical Downlink Shared Channel
PRACH Physical Random Access CHannel
PRB Physical Resource Block
PUCCH Physical Uplink Control Channel
PUSCH Physical Uplink Shared Channel
(P) SCCH (Physical) Sidelink Control Channel
PSS Primary Synchronisation Signal (ing)
PT-RS Phase Tracking Reference signalling
(P) SSCH (Physical) Sidelink Shared Channel
QAM Quadrature Amplitude Modulation
OCC Orthogonal Cover Code
QPSK Quadrature Phase Shift Keying
PSD Power Spectral Density
RAN Radio Access Network
RAT Radio Access Technology
RB Resource Block
RE Resource Element
Re Real part (e.g., for pi/2*BPSK) modulation
RNTI Radio Network Temporary Identifier
RRC Radio Resource Control
RS Reference Signal
RX Receiver, Reception, Reception-related/side
SA Scheduling Assignment
SC-FDE Single Carrier Frequency Domain Equalisation
SC-FDM/A Single Carrier Frequency Division Multiplex/Multiple Access
SCI Sidelink Control Information
SINR Signal-to-interference-plus-noise ratio
SIR Signal-to-interference ratio
SNR Signal-to-noise-ratio
SR Scheduling Request
SRS Sounding Reference Signal(ing)
SSS Secondary Synchronisation Signal (ing)
SVD Singular-value decomposition
TB Transport Block
TDD Time Division Duplex
TDM Time Division Multiplex
T-RS Tracking Reference signalling or Timing Reference signalling
TX Transmitter, Transmission, Transmission-related/side
UCI Uplink Control Information
UE User Equipment
URLLC Ultra Low Latency High Reliability Communication
VL-MIMO Very-large multiple-input-multiple-output
WD Wireless Device
ZF Zero Forcing
ZP Zero-Power, e.g. muted CSI-RS symbol

Abbreviations may be considered to follow 3GPP usage if applicable.

1: A method of operating a ray tracing system, the method comprising launching rays from one or more transmission objects for determining rays hitting one or more reception object, wherein launching comprises launching a successor ray based on a predecessor ray hitting a proximity object, wherein the proximity object encloses a reception object.

2: The method according to claim 1, wherein the successor ray is parametrised based on the predecessor ray.

3: The method according to claim 1, wherein the successor ray is parametrised based on the proximity object.

4: The method according to claim 1, wherein the successor ray has a different angle than the predecessor ray and is parametrised to hit the proximity object.

5: The method according to claim 1, wherein a second successor ray is launched based on the successor ray not hitting the proximity object and/or the reception object.

6: The method according to claim 1, wherein the rays launched represent radio signalling.

7: The method according to claim 1, wherein channel properties for radio signalling are estimated and/or determined based on rays.

8: The method according to claim 1, wherein the proximity object is a 2D or 3D representation.

9: The method according to claim 1, wherein there are multiple proximity objects, each of which encloses a different reception object.

10: The method according to claim 1, the method comprising simulating an environment, the one or more transmission objects representing actual transmitters of radio signalling in the environment, and the one or more reception objects representing actual receivers in the environment.

11: The method according to claim 1, the method being based on measurement information and/or environment information received by the ray tracing system.

12: The method according to claim 1, the method comprising providing information to, and/or controlling one or more nodes of a wireless communication network, based on rays determined to hit one or more of the reception objects.

13: A ray tracing system adapted to perform the method according to claim 1.

14: A non-transitory computer readable storage medium comprising instructions that, when executed by processing circuitry, cause the processing circuitry to perform a method of operating a ray tracing system, the method comprising launching rays from one or more transmission objects for determining rays hitting one or more reception object, wherein launching comprises launching a successor ray based on a predecessor ray hitting a proximity object, wherein the proximity object encloses a reception object.

15. (canceled)
